(19) United States
(12) Patent Application Publication
(10) Pub. No.: US 2012/0202098 A1
(43) Pub. Date: Aug. 9, 2012

(54) MULTICELL BATTERY ENCLOSURE AND METHOD OF MANUFACTURING THE SAME

(76) Inventor: Edward C. Fontana, Rockwall, TX (US)

(21) Appl. No.: 13/363,573

(22) Filed: Feb. 1, 2012

Related U.S. Application Data
(60) Provisional application No. 61/439,049, filed on Feb. 3, 2011.

(51) Int. Cl. H01M 2/10

(52) U.S. Cl. 429/99; 429/100; 29/469

(57) ABSTRACT

A battery enclosure and a method of manufacturing a battery enclosure. In one embodiment, the battery enclosure includes: (1) an outer shell, (2) an inner capsule configured to contain multiple batteries, (3) a deformable structure configured to support the inner capsule within the outer shell and (4) at least one conductor extending from the inner capsule through the outer shell and configured to convey power to an external load.

### CROSS-REFERENCE TO RELATED APPLICATION

This application claims the benefit of U.S. Provisional Application Ser. No. 61/439,049, filed by Fontana on Feb. 3, 2011, entitled “Protective Battery Enclosure,” commonly assigned with this application and incorporated herein by reference.

### TECHNICAL FIELD

This application is directed, in general, to a battery packages and, more specifically, to a multicell battery enclosure and a method of manufacturing the same.

### BACKGROUND

As applications demand considerable energy storage in smaller and smaller packages, batteries based on lithium and other sensitive elements come into play. The prospect of deploying energy-dense batteries is attractive to many telecommunications operators, but they are nonetheless wary of mass recalls of laptop computer batteries and widespread reports of problems with lithium-metal-polymer batteries in general. The publicity associated with such incidents is inevitably highly adverse for both the battery manufacturer and the telecommunications operator.

Due in part to the sensitivity of lithium-based batteries to damage and the harm they can cause when damaged, Telcordia Technologies Generic Requirements 3150-CORE (“Generic Requirements for Secondary Non-Aqueous Lithium Batteries”) requires such batteries to survive a 16-foot drop on their terminals in an unpackaged state. Meeting this standard is proving to be a challenge for battery designers.

### SUMMARY

A battery enclosure and a method of manufacturing a battery enclosure. In one embodiment, the battery enclosure includes: (1) an outer shell, (2) an inner capsule configured to contain multiple batteries, (3) a deformable structure configured to support the inner capsule within the outer shell and (4) at least one conductor extending from the inner capsule through the outer shell and configured to supply convey power to an external load.

Another aspect provides a method of manufacturing a battery enclosure. In one embodiment, the method includes: (1) providing an outer shell, (2) forming an inner capsule configured to contain multiple batteries, (3) configuring a deformable structure between the inner capsule and the outer shell and (4) causing at least one conductor to extend from the inner capsule through the outer shell, the at least one conductor configured to supply convey power to an external load.

### BRIEF DESCRIPTION

Reference is now made to the following descriptions taken in conjunction with the accompanying drawings, in which:

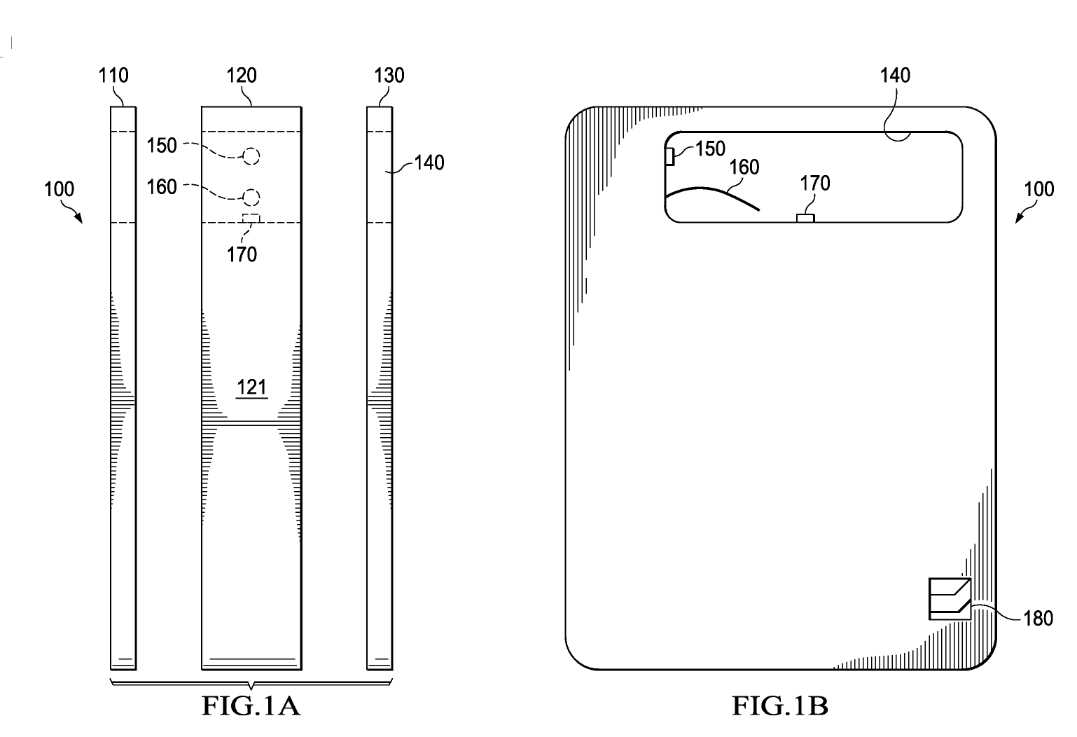

FIG. 1A is a left-side elevational view of one embodiment of a battery enclosure;

FIG. 1B is a front-side elevational view of the battery enclosure of FIG. 1A;

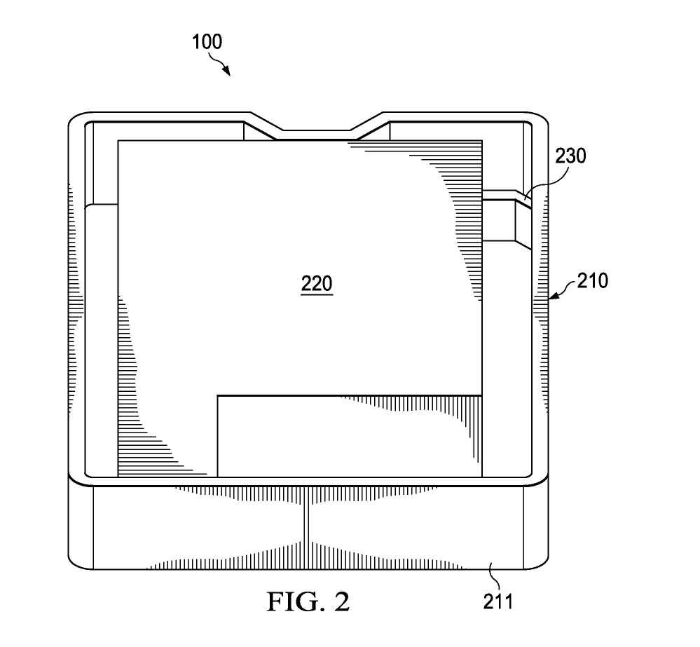

FIG. 2 is an isometric view of another embodiment of a battery enclosure;

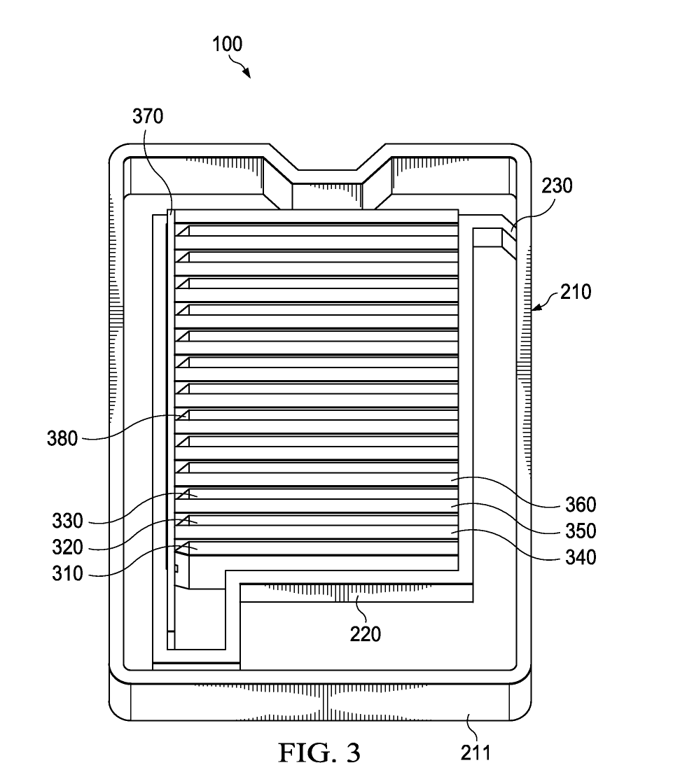

FIG. 3 is an isometric view of one embodiment of a clamshell portion of the battery enclosure embodiment of FIG. 2;

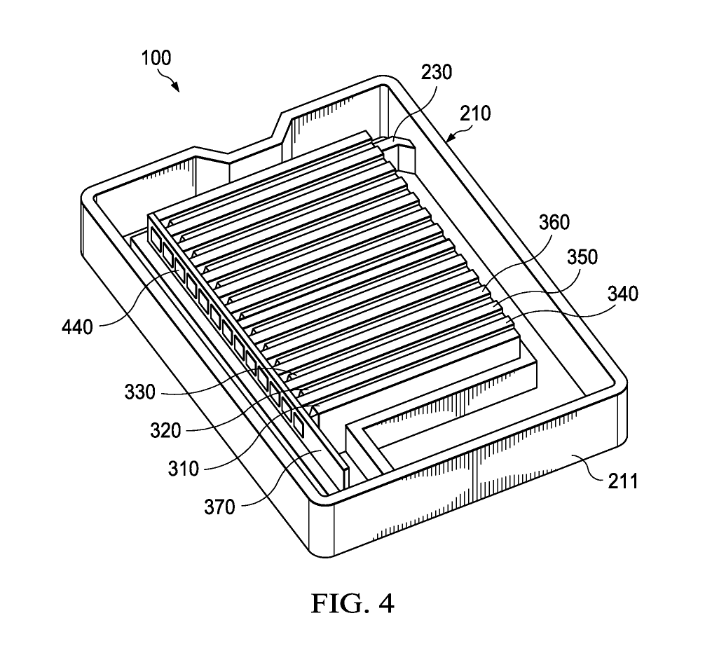

FIG. 4 is another isometric view of the clamshell portion embodiment of FIG. 3;

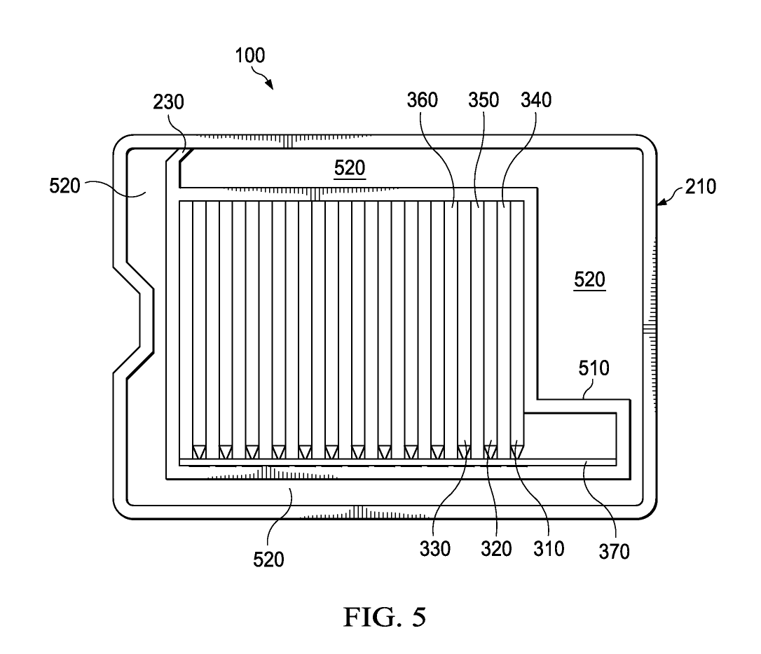

FIG. 5 is a plan view of the clamshell portion embodiment of FIG. 3; and

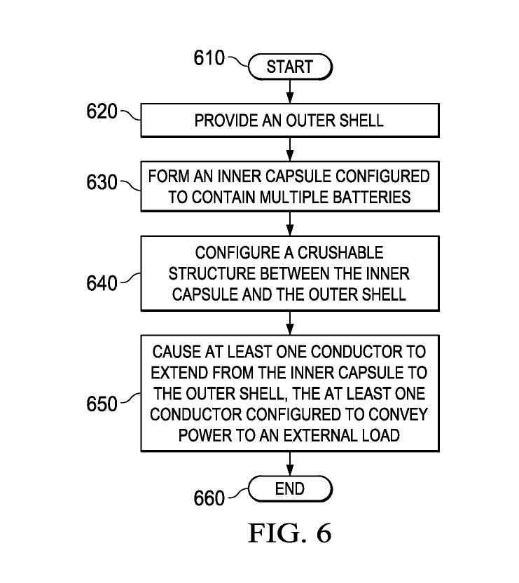

FIG. 6 is a flow diagram of one embodiment of a method of manufacturing a battery enclosure.

### DETAILED DESCRIPTION

As stated above, a major battery safety standard requires batteries to survive a 16-foot drop on their terminals in an unpackaged state, which is proving to be a significant hurdle for battery designers. What is needed is a battery enclosure that provides an improved margin of safety to accommodate a collision resulting from dropping or other mishandling.

Described herein are various embodiments of a battery enclosure for lithium-based and other batteries. The various embodiments are configured to enclose multiple batteries in an inner capsule and incorporate a deformable structure configured to support the inner capsule within an outer shell. The deformable structure is configured to absorb energy that would otherwise be directed into, and possibly harm, the batteries. At least one conductor extends from the inner capsule through the outer shell and is configured to supply convey power to an external load. Certain of the embodiments are further configured to incorporate a handle by which a hand can grasp and carry the battery enclosure, making inadvertent drops less likely.

Certain embodiments of the battery enclosure further provide electrical interconnections for the multiple batteries such that they can cooperate to provide a single power source. In one embodiment, the inner capsule includes busbars that provide the electrical interconnections. In another embodiment, the inner capsule includes a rigid member configured to support conductors that provide the electrical interconnections. In a more specific embodiment, the rigid member is a circuit board.

Certain related embodiments provide one or more external terminals or umbilicals configured to allow the batteries to be connected to an external load while still within the battery enclosure. In one embodiment, the one or more external terminals are recessed to protect them from damage from a collision. In another embodiment, the external terminals or umbilicals are mounted on a circuit board that also provides electrical connections for the multiple batteries.

Still other embodiments provide one or more status indicators mounted on or in the outer shell. In one embodiment, the one or more status indicators include a light-emitting diode (LED). In another embodiment, the one or more status indicators are recessed to protect them from damage from a collision. In yet another embodiment, the one or more status indicators are mounted on a circuit board that also provides electrical connections for the multiple batteries.

Other embodiments provide an inspection port in or on the surface of the outer shell by which visual inspection can be made to determine whether or not the battery enclosure has suffered a collision of at least a magnitude sufficient to deform the deformable structure. Further embodiments provide buffer elements that divide the multiple batteries into separate compartments. Still further embodiments provide surplus volume in the separate compartments configured to accommodate an exothermic reaction that may occur as a result of damage to a battery. The additional volume tends to spread the exothermic reaction over time, rendering a damaged battery more likely to vent and “fizzle” than explode.

Yet further embodiments provide access to interstices between the outer shell and the inner capsule and about the deformable structure such that a substance (e.g., a cement or potting compound) can be introduced into the interstices, typically once the battery enclosure has been delivered and installed. In some embodiments, the substance hardens after it has been introduced to render the battery enclosure relatively stiff, strong and able to support a load stacked on top of it (e.g., other battery enclosures).

Various of the above-described embodiments enjoy one or more of the following benefits: (1) increased battery safety resulting from collision damage, (2) a handle design for the outer shell that protects one or more status indicators or one or more terminals or umbilicals, (3) an outer shell that accommodates an inspection for internal damage or evidence of abrasions and (4) surplus volume for batteries to expand thermally and engage in a more controlled (time-extended) exothermic reaction if damaged.

FIG. 1A is a left-side elevational view of one embodiment of a battery enclosure 100. The battery enclosure 100 includes an outer shell having a first cap 110, a central portion 120 and a second cap 130. The central portion 120 includes a sidewall 121. First and second caps 110, 130 are configured to be joined to the central portion 120 where they cooperate with the sidewall 121 to form the outer shell. In various embodiments, the first and second caps 110, 130 are joined to the central portion by one or more fasteners (e.g., rivets, screws or bolts) or adhesive. A handle 140 is located though the outer shell, namely the first and second caps 110, 130 and the central portion 120. The embodiment of FIG. 1A shows both an external connector 150 and an umbilical 160 passing through the central portion 120 of the outer shell. In the embodiment of FIG. 1A, the external connector 150 and the umbilical 160 are recessed in (located somewhere on the interior surface of) the handle 140.

Either the external connector 150 or the umbilical 160 can be employed to convey power from one or more of the multiple batteries in the battery enclosure 100 to an external load. Other embodiments lack either the external connector 150 or the umbilical 160.

The embodiment of FIG. 1A also shows a status indicator 170 recessed in the handle 140. In the illustrated embodiment, the status indicator 170 indicates the charge-state of one or more of the multiple batteries in the battery enclosure 100. Alternative embodiments include further status indicators configured to indicate other attributes of the batteries (e.g., the number of batteries or the output voltage) or the battery enclosure 100 (e.g., whether or not the battery enclosure 100 has suffered a collision).

FIG. 1B is a front-side elevational view of the battery enclosure of FIG. 1A. FIG. 1B provides another view of the handle 140, the external connector 150, the umbilical 160 and the status indicator 170.

The embodiment of FIG. 1B also shows an inspection port 180 in the outer shell. In the illustrated embodiment, the inspection port 180 is an opening or includes a section of clear material through which visual inspection can be made to determine whether or not the battery enclosure 100 has suffered a collision of at least a magnitude sufficient to deform the deformable structure. In an alternative embodiment, the inspection port 180 includes a section of material that is softer (i.e., more abradable) than the material constituting the remainder of the outer shell. The softer material is configured to provide evidence of scuffing or rubbing that indicates rough handling of the battery enclosure 100 and perhaps a collision of at least a magnitude sufficient to deform the deformable structure.

FIG. 2 is an isometric view of another embodiment of the battery enclosure 100 having an outer shell 210, an inner capsule 220 and a deformable structure 230. In this embodiment, the outer shell 210 does not completely surround and enclose the inner capsule 220 as it did in FIGS. 1A and 1B. Instead, the outer shell 220 is at least predominantly a sidewall 211 that extends about minor surfaces of the inner capsule and having a height that is greater than that of the minor surfaces of the inner capsule 220. As a result, and as is apparent in FIG. 2, substantial portions of the inner capsule 220 are visible from outside of the battery enclosure 100. (In other words, the inspection port 180 of FIG. 1B thus may be thought of as extending over most of the outer shell 220.) However, because the height of the sidewall 211 is greater than that of the minor surfaces of the inner capsule 220, the inner capsule is at least partially isolated from collisions between the sidewall 211 and flat surfaces (not shown).

A deformable structure 230 provides support for the inner capsule 220 within the outer shell 210. In the embodiment of FIG. 2, the deformable structure 210 consists of a single member, composed of plastic, that joins the inner capsule 220 to the sidewall 211 of the outer shell 210.

In one alternative embodiment, the deformable structure 230 has multiple members. In another alternative embodiment, the deformable structure 230 is not joined to one or both of the inner capsule 230 or the sidewall 211 but instead merely lies within the outer shell 210 and the inner capsule 220, perhaps retained by frictional resistance. In yet another embodiment, the deformable structure 230 is not composed only of plastic, but rather of one or more additional or alternative substances that nonetheless are configured to deform (e.g., bend, compress, twist, elongate or collapse) at least temporarily in response to a collision or otherwise absorb at least some energy from the collision.

In FIG. 2, it is apparent that if the battery enclosure 100 is dropped or otherwise suffers a collision, the inner capsule 220 moves relative through the outer shell 210, deforming the deformable structure 230 and absorbing at least some of the energy from the collision. The inner capsule 220 contains the one or more batteries, keeping the energy from the collision from being focused on a particular battery or batteries and thereby reducing the likelihood that a particular battery or batteries will be damaged from the collision.

In the embodiment of FIG. 2, the outer shell 210, the inner capsule 220 and the deformable structure 230 may be formed by first forming an opposing pair of “clamshell” portions (not shown in FIG. 2) and then mating the opposing pair of clamshell portions together. Each of the opposing pair of clamshell portions contains a major surface of the inner capsule. Remaining elements of the outer shell 210, the inner capsule 220 and the deformable structure 230 may be apportioned between the opposing pair of clamshell portions as desired.

FIG. 3 is an isometric view of one embodiment of a clamshell portion of the battery enclosure embodiment of FIG. 2. FIG. 3 illustrates a clamshell portion that includes elements of the outer shell 210, the inner capsule 220 and the deformable structure 230. The inner capsule is illustrated as including buffer elements 310, 320, 330. In the illustrated embodiment, the buffer elements 310, 320, 330 are configured to create separate compartments for multiple batteries 340, 350, 360. Also in the illustrated embodiment, the buffer elements 310, 320, 330 have a thickness such that the separate compartments provide surplus volume for the batteries 340, 350, 360.

In the illustrated embodiment, the surplus volume is provided to accommodate an exothermic reaction in or around one or more of the batteries 340, 350, 360. In the illustrated embodiment, the buffer elements 310, 320, 330 are spaced farther apart than the thickness of the batteries 340, 350, 360 to provide the surplus volume. In an alternative embodiment, the buffer elements 310, 320, 330 compress to provide the surplus volume.

As stated above, at least one conductor provides electrical interconnections for the multiple batteries 340, 350, 360, thereby allowing the multiple batteries 340, 350, 360 to provide a single power source. In one embodiment, busbars may be employed to provide these interconnections. FIG. 3 shows an alternative embodiment in which a circuit board 370 is employed to mount first and second conductors (not separately referenced in FIG. 3). Terminals of the multiple batteries 340, 350, 360 are coupled to the conductors. For example, FIG. 3 shows terminals 380 of the battery 340 as coupled to the conductors. In the illustrated embodiment, the conductors couple the batteries 340, 350, 360 together serially. In an alternative embodiment, the conductors couple the batteries 340, 350, 360 together in parallel. Those skilled in the pertinent art understand that the conductors may couple the batteries 340, 350, 360 in many different ways without departing from the broad scope of the invention.

FIG. 4 is another isometric view of the clamshell portion embodiment of FIG. 3. FIG. 4 provides a better view of the circuit board and pad portions 410 of the conductors mounted thereon. The pad portions 410, which are located on both sides of the circuit board 370 embodiment of FIG. 4, provide a place on which battery terminals can be soldered or against which battery terminals can resiliently bear on the conductors to make electrical contact.

FIG. 5 is a plan view of the clamshell portion embodiment of FIG. 3. FIG. 5 shows particularly well how the buffer elements 310, 320, 330 and the batteries 340, 350, 360 are interlaced in the illustrated embodiment and further how the circuit board 370 extends to allow the conductors to terminate in at least one external connector and/or at least one umbilical. Although not shown in FIG. 5, the external connector or umbilical may extend downwardly through a portion 510 of the inner capsule 220 to couple to the conductors on the circuit board 370.

FIG. 5 further shows interstices 520 between the outer shell and the inner capsule and about the deformable structure 210. A substance such as a cement or a potting compound may be introduced into the interstices 520, typically once the battery enclosure 100 has been installed at its intended destination. In some embodiments, the substance hardens after it has been introduced to render the battery enclosure 100 relatively stiff, strong and able to support a load stacked on top of it (e.g., other battery enclosures).

FIG. 6 is a flow diagram of one embodiment of a method of manufacturing a battery enclosure. The method begins in a step 610. In a step 620, an outer shell is provided. In a step 630, an inner capsule is formed that is configured to contain multiple batteries. In a step 640, a deformable structure is configured between the inner capsule and the outer shell. In one embodiment, the configuring of the deformable structure includes creating separate compartments for the multiple batteries with buffer elements. In a related embodiment, the creating of the separate compartments includes creating the separate compartments with surplus volume configured to accommodate an exothermic reaction.

In a step 650, at least one conductor is caused to extend from the inner capsule through the outer shell, the at least one conductor configured to convey power to an external load. In one embodiment, the causing the at least one conductor to extend from the inner capsule through the outer shell includes providing, with the at least one conductor, electrical interconnections for the multiple batteries, the multiple batteries thereby configured to provide a single power source. In one embodiment, the causing the at least one conductor to extend from the inner capsule through the outer shell includes supporting the at least one conductor on a circuit board. In one embodiment, the causing the at least one conductor to extend from the inner capsule through the outer shell includes causing the at least one connector to be recessed in the handle.

Some embodiments of the method include a further step of providing at least one status indicator recessed in the handle. Other embodiments of the method include a further step of forming in inspection port in the outer shell. Yet other embodiments of the method include a further step of placing a substance in interstices between the outer shell and the inner capsule and about the deformable structure. The method ends in an end step 660.

Those skilled in the art to which this application relates will appreciate that other and further additions, deletions, substitutions and modifications may be made to the described embodiments.

What is claimed is:

1. A battery enclosure, comprising:
an outer shell;
an inner capsule configured to contain multiple batteries;
a deformable structure configured to support said inner capsule within said outer shell; and
at least one conductor extending from said inner capsule through said outer shell and configured to convey power to an external load.

2. The battery enclosure as recited in claim 1 wherein said inner capsule includes buffer elements configured to create separate compartments for said multiple batteries.

3. The battery enclosure as recited in claim 2 wherein said separate compartments provide surplus volume configured to accommodate an exothermic reaction.

4. The battery enclosure as recited in claim 1 wherein said at least one conductor provides electrical interconnections for said multiple batteries, said multiple batteries thereby configured to provide a single power source.

5. The battery enclosure as recited in claim 1 wherein said inner capsule includes a circuit board configured to support said at least one conductor.

6. The battery enclosure as recited in claim 1 wherein said at least one conductor terminates in one of:
at least one external connector, and
at least one umbilical.

7. The battery enclosure as recited in claim 6 further comprising a handle located through said outer shell and wherein said at least one connector is recessed in said handle.

8. The battery enclosure as recited in claim 1 further comprising at least one status indicator recessed in said handle.

9. The battery enclosure as recited in claim 1 wherein said outer shell includes an inspection port.

10. The battery enclosure as recited in claim 1 further comprising a substance located in interstices between said outer shell and said inner capsule and about said deformable structure.

11. A method of manufacturing a battery enclosure, comprising:
providing an outer shell;
forming an inner capsule configured to contain multiple batteries;
configuring a deformable structure between said inner capsule and said outer shell; and
causing at least one conductor to extend from said inner capsule through said outer shell, said at least one conductor configured to convey power to an external load.

12. The method as recited in claim 11 wherein said configuring said deformable structure comprises creating separate compartments for said multiple batteries with buffer elements.

13. The method as recited in claim 12 wherein said creating comprises creating said separate compartments with surplus volume configured to accommodate an exothermic reaction.

14. The method as recited in claim 11 wherein said causing comprises providing, with said at least one conductor, electrical interconnections for said multiple batteries, said multiple batteries thereby configured to provide a single power source.

15. The method as recited in claim 11 wherein said causing comprises supporting said at least one conductor on a circuit board.

16. The method as recited in claim 11 wherein said at least one conductor terminates in one of:
at least one external connector, and
at least one umbilical.

17. The method as recited in claim 16 wherein said causing comprises causing said at least one connector to be recessed in a handle located through said outer shell.

18. The method as recited in claim 11 further comprising providing at least one status indicator recessed in said handle.

19. The method as recited in claim 11 further comprising forming in inspection port in said outer shell.

20. The method as recited in claim 11 further comprising placing a substance in interstices between said outer shell and said inner capsule and about said deformable structure.
